(19) United States
(12) Patent Application Publication
(10) Pub. No.: US 2017/0171636 A1
(43) Pub. Date: Jun. 15, 2017

(54) PROVIDING INFORMATION TO A MEDIA DEVICE WHEN SATELLITE SERVICE TO THE MEDIA DEVICE IS DISRUPTED

(71) Applicant: AT&T INTELLECTUAL PROPERTY I, L.P., ATLANTA, GA (US)

(72) Inventors: Michael Devlin, Leander, TX (US); James H. Pratt, Round Rock, TX (US)

(21) Appl. No.: 14/966,741

(22) Filed: Dec. 11, 2015

(51) Int. Cl. H04N 21/647; H04N 21/2665; H04N 21/462; H04N 21/218; H04N 21/61; H04N 21/81; H04N 21/24

(52) U.S. Cl. CPC H04N 21/64707; H04N 21/814; H04N 21/64738; H04N 21/2665; H04N 21/2402; H04N 21/218; H04N 21/6112; H04N 21/6143; H04N 21/4622

(57) ABSTRACT

A method includes detecting, at a server of a satellite distribution system, a disruption in satellite service to a media device. The method includes generating, at the server, a data stream from multiple content sources in response to the disruption. The method includes sending the data stream from the server to the media device via a terrestrial distribution system.

### FIELD OF THE DISCLOSURE

The present disclosure is generally related to providing information to a media device when satellite service to the media device is disrupted.

### BACKGROUND

A satellite television service provider communicates media content to subscribers by sending satellite television signals to subscriber devices. The satellite signals may be disrupted by storms or due to distribution issues. If a satellite television signal is disrupted, content sent to the subscribers may have degraded audio content or video content, or the content may be lost entirely. Disruptions to satellite service may occur when subscribers need information to determine how to accommodate current environmental conditions (e.g., whether to seek shelter in the event of a tornado).

### BRIEF DESCRIPTION OF THE DRAWINGS

FIG. 1 is a block diagram of an embodiment of a system of providing information to satellite television subscriber devices when satellite service is disrupted.

FIG. 2 is a flowchart of a first embodiment of a method of providing information to a media device when satellite service to the media device is disrupted.

FIG. 3 is a flowchart of a second embodiment of a method of providing information to a media device when satellite service to the media device is disrupted.

FIG. 4 is a block diagram of a first embodiment of a display sent from a media device to a display device.

FIG. 5 is a block diagram of a second embodiment of the display sent from the media device to the display device depicted in FIG. 4.

FIG. 6 is a block diagram of an illustrative embodiment of a general computer system.

### DETAILED DESCRIPTION

Systems and methods disclosed herein enable information from multiple content sources to be provided to a media device from a satellite distribution system when content from a satellite service is unavailable (e.g., the satellite service is disrupted or degraded). The media device determines that quality of media content received from the satellite service is below a threshold quality and sends a disruption message to the satellite distribution system via a terrestrial distribution system. In response to the disruption message, the satellite distribution system sends the information from the multiple content sources to the media device via the terrestrial distribution system. The media device may process the information and provide the information to one or more output devices (e.g., a display device, an audio output device, etc.). As illustrative, non-limiting examples, the information may include emergency information, weather information, video content, text content, audio content, other content (or combinations thereof) that inform one or more recipients about current conditions. The terrestrial distribution system may be a wired communication network, a wireless communication network, or a combination thereof. Examples of terrestrial distribution systems include a cable system, a digital subscriber line (DSL) system, a wireless wide area network, a metropolitan area network, or a wireless local area network (among other alternatives).

When a disruption occurs, the media device may map the information to a particular channel that is intuitive for users to find (e.g., channel 911). The media device may automatically tune to the particular channel when the disruption is detected and output the information (upon receipt of the information). When satellite service is available (e.g., before the disruption), general information (e.g., information from multiple regional content sources associated with a region where the media device is located) may be presented when the media device is tuned to the particular channel. After the disruption is detected, the information provided to the media device may change from the general information to more specific information (e.g., information associated with an area where the media device is located that is more specific than the general information for the region). For example, when the media device is located in central Texas (e.g., Austin, Tex.), the particular channel may display general information associated with the central Texas region when satellite service is available (e.g., before the disruption). To illustrate, the central Texas regional information may include alerts and current conditions for a large region that includes the cities of Austin, San Antonio, and Waco. After detecting that the satellite service is disrupted, the information provided to the media device may change to information that is more specific to Austin, Tex. and surrounding cities. To illustrate, the more specific information may include information from multiple local content sources associated with the city of Austin, such as a feed from a news channel associated with Austin, a feed from a national news channel available in Austin, other information, or combinations thereof.

In the event of a disruption of a satellite service, some people may have an option to obtain local information using an alternative device (e.g., a wireless mobile communication device that may utilize a terrestrial network that may not be impacted by the satellite service disruption). In the present disclosure, use of the particular channel may provide a larger display area for content presentation, content from multiple sources (e.g., television sources and web content sources), content tailored to the area associated with the media device, and an automatic change to the particular channel when the satellite service is disrupted. The media device may also provide information indicative of a status of the satellite service (e.g., that the disruption has been mitigated).

In an illustrative embodiment, a method includes detecting, at a server of a satellite distribution system, a disruption in satellite service to a media device. The method includes generating, at the server, a data stream from multiple content sources in response to the disruption. The method also includes sending the data stream from the server to the media device via a terrestrial distribution system.

In an illustrative embodiment, a system includes a processor and a memory coupled to the processor. The memory stores instructions executable by the processor to perform operations. The operations include sending a disruption message to a network device of a satellite distribution system via a terrestrial distribution system. The disruption message is sent in response to a determination that a quality of a content stream received via a satellite service from the satellite distribution system is below a threshold quality. The operations also include receiving a data stream from the satellite distribution system via the terrestrial distribution system in response to the disruption message. The satellite distribution system generates the data stream from multiple content sources in response to the disruption message.

In an illustrative embodiment, a computer-readable storage device stores instructions, that when executed by a processor, cause the processor to perform various operations. The operations include sending a disruption message to a network device of a satellite distribution system via a terrestrial distribution system. The disruption message is sent in response to a determination that a quality of media content received via a satellite service from the satellite distribution system is below a threshold quality. The operations also include receiving a data stream from the satellite distribution system via the terrestrial distribution system in response to the disruption message. The satellite distribution system generates the data stream from multiple content sources in response to the disruption message.

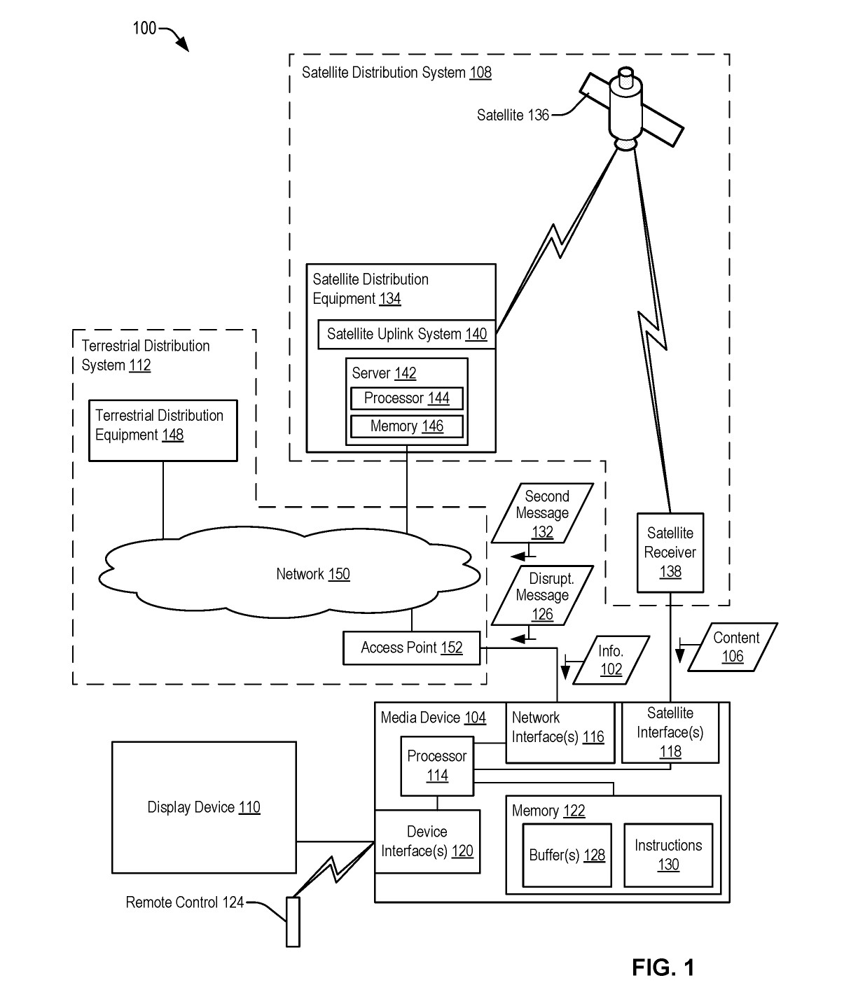

FIG. 1 is a block diagram of a particular embodiment of a system 100 for providing information 102 to a media device 104 when satellite service to the media device 104 is disrupted. During normal operation (e.g., when the satellite service is not disrupted), the media device 104 may receive content 106 from a satellite distribution system 108 via a satellite service and may send some or all of the content 106 to one or more output devices (e.g., a display device 110, a sound system, a haptic device, or combinations thereof). During a disruption of the satellite service, the satellite distribution system 108 may provide the information 102 to the media device 104 via a terrestrial distribution system 112.

The media device 104 may include or correspond to a set-top box device, a gaming system, a computer system, a portable communication device (e.g., a tablet computer, a mobile communication device, etc.), another type of device, or combinations thereof. The media device 104 may receive media content via the satellite service and may output processed media content to the one or more output devices. The media device 104 may include a processor 114 that is coupled to a network interface 116 (or multiple network interfaces), a satellite interface 118, a device interface 120 (or multiple device interfaces), and a memory 122.

The network interface(s) 116 may enable the media device 104 to communicate via the terrestrial distribution system 112. The satellite interface 118 may enable the media device 104 to communicate via the satellite distribution system 108. The device interface(s) 120 may enable wired and/or wireless connections of devices to the media device 104. The devices may include, but are not limited to, the display device 110, a sound system, a remote control 124, game controllers, haptic devices, other devices, or combinations thereof.

The memory 122 may store data, such as settings and stored media content. The settings may include values for various options associated with the media device 104. The values may be accessed and changed via one or more configuration interfaces. For example, the settings may include first values that specify what content the information 102 contains and presentation locations for the content on the display device 110, when the media device 104 detects that a quality of content received via the satellite service is below a threshold quality. The user may change default settings for the first values via a user interface to customize the first values. Data associated with the first values may be provided to the satellite distribution system 108 in a disruption message 126 when disruption of the content 106 is detected so that appropriate information is provided to the media device 104 in response to the disruption message 126.

The memory 122 may include a buffer 128 (or multiple buffers). The buffer(s) 128 may provide temporary storage for media content that is to be sent to one or more output devices (e.g., the display device 110). The buffer(s) 128 may inhibit disruptions to processed media content being sent to the one or more output devices.

The memory 122 may also include instructions 130 executable by the processor 114 to perform operations. The instructions 130 may be executable by the processor 114 to receive content 106 from the satellite distribution system 108 via the satellite service, receive a request from a control device (e.g., the remote control 124) for a particular channel of the content 106, retrieve the particular channel from the content, process media content corresponding to the particular channel, and output the media content to the one or more output devices. The instructions 130 may be executable by the processor 114 to monitor quality of the content 106 received via the satellite service, send the disruption message 126 to the satellite distribution system 108 via the terrestrial distribution system 112 when the quality is below a threshold quality, receive the information 102 via the terrestrial distribution system 112 in response to the disruption message 126, process the information 102, and output the media content corresponding to the information 102 to the one or more output devices.

The instructions 130 may also be executable by the processor 114 to determine when the quality of the content received via the satellite service is at or above the threshold quality after sending the disruption message 126, and send a second message 132 to the satellite distribution system 108 after receiving an indication to return to the satellite service. The satellite distribution system 108 may stop sending the information to the media device 104 in response to the second message 132.

The satellite distribution system 108 may include satellite distribution equipment 134, one or more satellites 136, and a satellite receiver 138 for each subscriber to the satellite service. The satellite distribution equipment 134 may include encoders, decoders, routers, one or more satellite uplink systems 140, a plurality of servers, other network devices, or combinations thereof. The one or more satellite uplink systems 140 may transmit media content corresponding to channels (e.g., channels of television content), other content, or combinations thereof, to the one or more satellites 136 for delivery to satellite receivers (e.g., the satellite receiver 138). The one or more satellite uplink systems 140 may also receive data from the one or more satellites 136 and forward the data to appropriate destinations (e.g., to a server 142 of the satellite distribution system 108, a server of the terrestrial distribution system 112, other devices, or combinations thereof). The satellite receiver 138 may include a satellite dish that is coupled to the satellite interface 118 of the media device 104.

The server 142 of the plurality of servers of the satellite distribution system 108 may communicate with the media device 104. For example, the server 142 may receive the disruption message 126 sent by the media device 104 via the terrestrial distribution system 112 when satellite service to the media device 104 is disrupted due to weather conditions or other causes. The media device 104 may determine that the satellite service is disrupted when the quality of content 106 received by the media device 104 is below a threshold quality. A determination that the quality of the content 106 is at or above the threshold quality may be based on received signal strength indicators associated with the content 106, bit error rates, frame error rates, other factors, or combinations thereof, satisfying corresponding quality thresholds. The server 142 may also receive the second message 132 from the media device 104 in response to the media device 104 receiving an indication to return to the satellite service after disruption of the satellite service ends.

The server 142 may include a processor 144 and a memory 146. The memory 146 may include instructions executable by the processor 144 to perform various operations. The operations may include receiving the disruption message 126 from the media device 104, generating the information 102 to send to the media device 104 from content sources, and sending the information 102 to the media device 104 via the terrestrial distribution system 112. Particular content to include in the information 102 may be determined based on the disruption message 126, or the information 102 may include default content when the disruption message 126 does not identify particular content to include in the information 102. The information 102 may include content that is different from content that is available from a single channel available to the media device 104 via the satellite service. For example, the information 102 may include weather alerts and warnings from the National Weather Service, a radar image associated with the area where the media device 104 is located, a newsfeed from a local news channel, a newsfeed from a national news channel, content from web sources, other content, or combinations thereof. The operations may also include receiving the second message 132 from the media device 104 that indicates that the media device 104 is using the satellite service, and stopping transmission of the information 102 to the media device 104 in response to the second message 132.

The terrestrial distribution system 112 may include terrestrial distribution equipment 148, a network 150, and an access point 152. The terrestrial distribution equipment 148 may include network devices (e.g., servers, multiplexers, demultiplexers, and routers) that enable delivery of data via the network 150. The network 150 may include public networks (e.g., the internet), private networks, mobile communication networks, other data networks, or combinations thereof. The access point 152 may enable a wireless connection or a wired connection to the network interface(s) 116 of the media device 104. The access point 152 may be, but is not limited to, a residential gateway, a customer premises equipment device, a wireless router, another device, or combinations thereof. The terrestrial distribution system 112 may enable communication between the media device 104 and network devices of the satellite distribution network 108 via a communication route that does not include the one or more satellites 136. For example, when the media device 104 determines that the satellite service is disrupted, the media device 104 may send the disruption message 126 to the server 142 of the satellite distribution system 108 using the access point 152, the network 150, and the terrestrial distribution equipment 148 of the terrestrial distribution system 112.

Thus, the system 100 of FIG. 1 enables the media device 104 to receive and output information when the satellite service to the media device 104 is disrupted. The ability of the media device 104 to receive the information during disruption of the satellite service enables recipients to be informed about local conditions during disruption of the satellite service. The information may include information from a number of different sources so that the recipients are aware of warnings or alerts associated with a cause that resulted in the disruption of the satellite service (e.g., a storm).

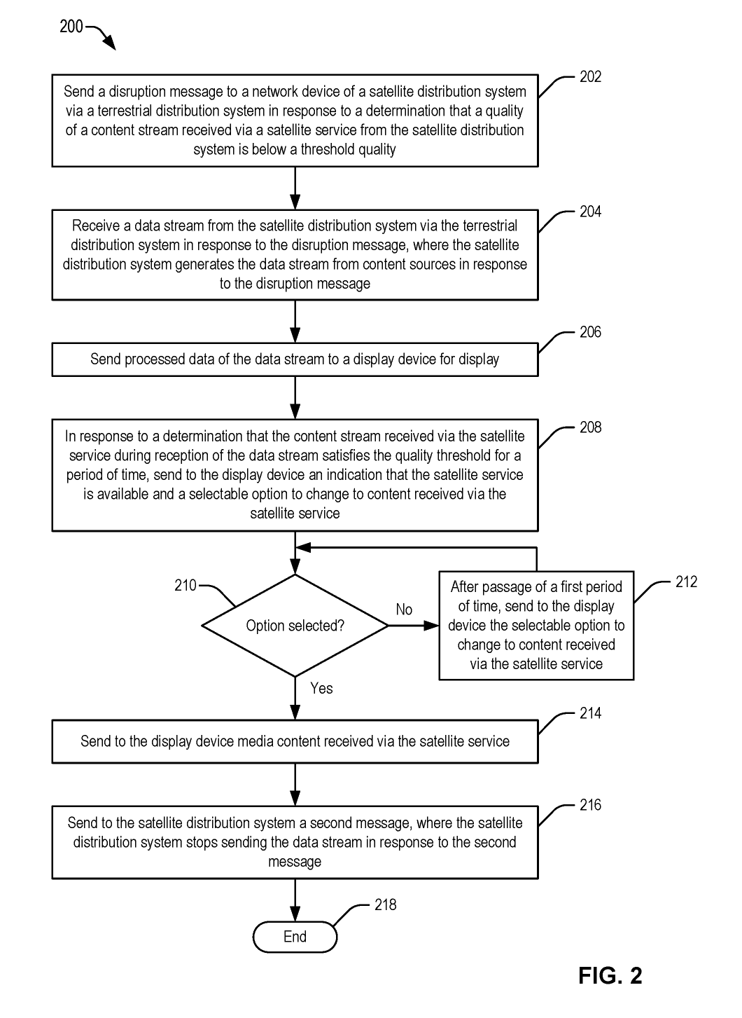

FIG. 2 shows a flowchart of a first embodiment of a method 200 of providing information to a media device when satellite service to the media device is disrupted. The method 200 may be performed by a media device (e.g., the media device 104 of FIG. 1). The media device may receive a content stream from one or more satellites of a satellite communication system. The media device may determine a quality of the content stream. When the quality of the content stream is at or above a threshold quality, the media device may process requested media content in the content stream and output processed media content corresponding to the requested media content to one or more output devices (e.g., a display device, a sound system, or both). A determination that the quality of the content stream is at or above the threshold quality may be based on received signal strength indicators associated with the content stream, bit error rates, frame error rates, other factors, or combinations thereof, satisfying corresponding quality thresholds.

The media device may send a disruption message to a network device (e.g., a server) of the satellite distribution system via a terrestrial distribution system in response to a determination that the quality of the content stream received via a satellite service from the satellite distribution system is below the threshold quality, at 202. The determination that the quality of the content stream is below the threshold quality may be based on received signal strength indicators associated with the content stream, bit error rates, frame error rates, other factors, or combinations thereof, failing to satisfy corresponding quality thresholds. The disruption message may include information from user settings of the media device that indicates the content of the data stream.

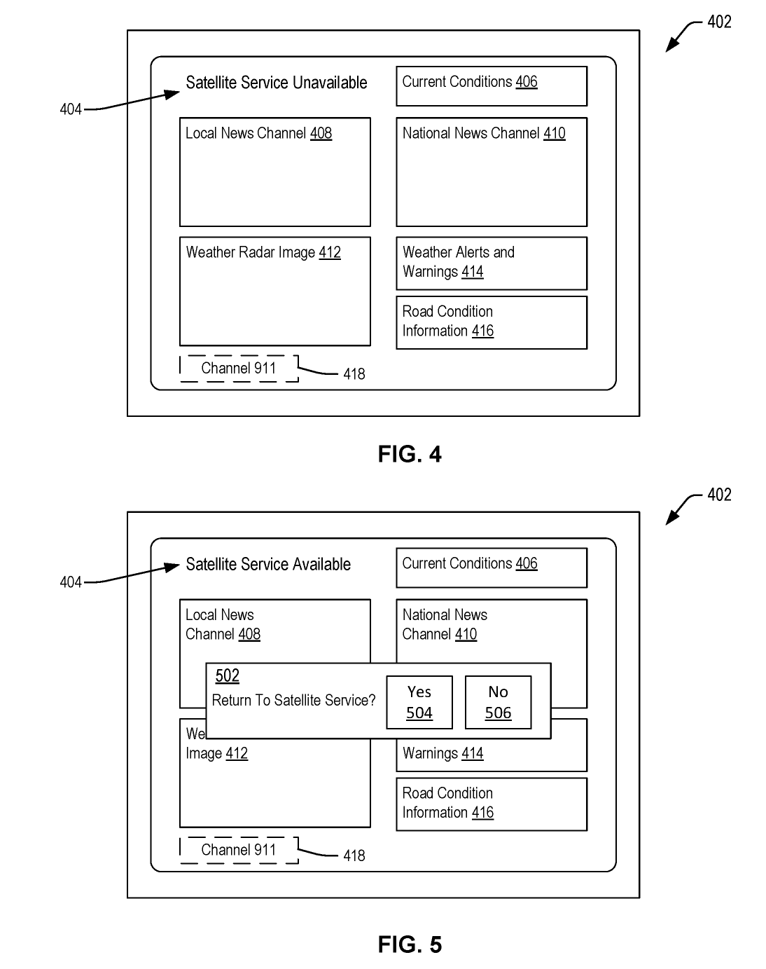

The media device may receive a data stream from the satellite distribution system via the terrestrial distribution system in response to the disruption message, at 204. The satellite distribution system generates the data stream from content sources in response to the disruption message. The content of the data stream may be determined from values included in the disruption message or may be default content when the disruption message does not include the values. The data stream may include weather information, traffic information, school closure information, emergency information, or combinations thereof. For example, the data stream may include data corresponding to a radar image for an area associated with the media device, one or more National Weather Service warnings or alerts for the area, content from one or more news channels, additional information, or combinations thereof. The media device may send particular content from the data stream to a display device, at 206. The particular content may include an indication that the satellite service is not available. FIG. 4 shows a block representation of a particular embodiment of the display device after the disruption.

In response to a determination that the content stream received via the satellite service during reception of the data stream satisfies the quality threshold for a period of time, the media device may send to the display device an indication that the satellite service is available and an option to change to content received via the satellite service, at 208. The period of time may be 1 minute, 5 minutes, or another period of time and may inhibit repetitive disruptions due to temporary restorations of the satellite service. FIG. 5 shows a block representation of the display device when the satellite service becomes available after the disruption.

The media device may determine whether the option to change is selected, at 210. The option may be selected by a viewer via use of a remote control device, by other user input, or by passage of a particular period of time without receiving user input (e.g., 30 seconds, 1 minute, or another period of time). The option may be declined by the viewer by selection of a decline button via the remote control or by other user input that declines the option.

When the option is declined, the media device may continue to send the particular content to the display device with the indication that the satellite service is available. After passage of a first period of time (e.g., 2 minutes, 5 minutes, or another period of time), the media device may send to the display device the selectable option to change to content received via the satellite service, at 212. The method 200 may then return to 210.

In response to selection of the option, at 210, the media device may send media content received via the satellite service to the display device, at 214. Selecting the option using the remote control or another input device may include, but is not limited to, selecting an accept button, selecting a channel up or channel down button, and entering a number that corresponds to a channel. When the accept button is used to select the option or after passage of the particular period of time without user input, the media content sent to the display device may be media content corresponding to a channel being received before the disruption or media content corresponding to a default start up channel when the media device, display device, or both, were turned on during the disruption.

The media device may send to the satellite distribution system a second message, at 216. The second message may be sent to the satellite distribution system via the satellite service, via the terrestrial distribution system, or both. The satellite distribution system may stop sending the data stream in response to the second message. The method 200 may then end, at 218.

Thus, the method 200 of FIG. 2 enables a media device that receives media content via the satellite service to receive a data stream via a terrestrial distribution system during disruption of the satellite service. The media device may provide processed content from the data stream to the display device. The satellite service may be disrupted due to weather or other causes. The content provided during the disruption may inform one or more viewers that satellite service is disrupted and may provide emergency information and/or other information that may be informative to the one or more viewers.

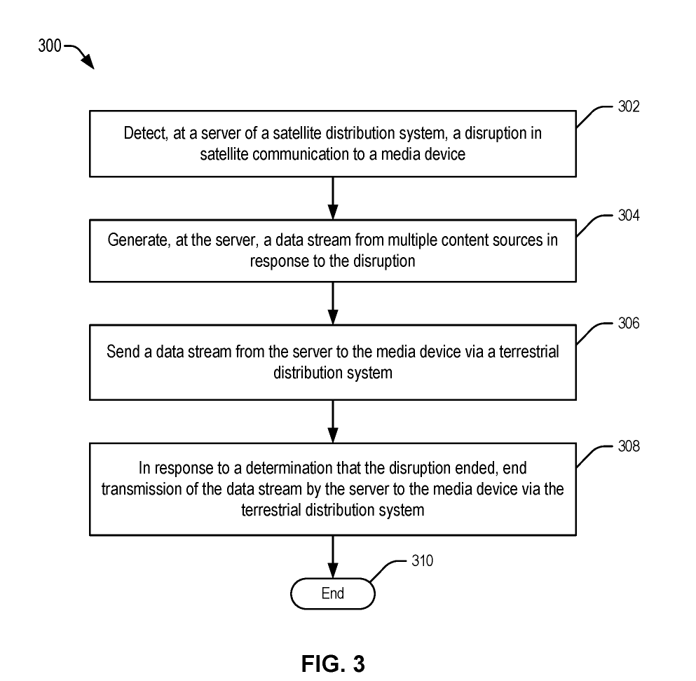

FIG. 3 shows a flowchart of a second embodiment of a method 300 of providing information to a media device when satellite service to the media device is disrupted. The method 300 may be performed by a server or other network device of a satellite distribution system (e.g., the server 142 of the satellite distribution system 108 of FIG. 1). The server of the satellite distribution system may detect a disruption in satellite communication to a media device, at 302. The server may detect the disruption by receiving a disruption message from the media device. For example, referring to FIG. 1, the server 142 may receive the disruption message 126 from the media device 104. The disruption message may indicate that quality of media content received by the media device via satellite communication is below a threshold quality threshold. The disruption message may be received by the network device via a terrestrial distribution system. The disruption message may also include values that indicate content to be included in a data stream sent to the media device.

In response to the disruption, the server may generate the data stream from multiple content sources, at 304. The content sources may be sources of television content, internet sources, or both. The data stream may include video content, audio content, or both. Particular content included in the data stream may be based on values of user settings included in the disruption message or may be default content. The data stream may include weather information, traffic information, school closure information, emergency information, one or more channel feeds, or other information, or combinations thereof. The weather information may include a radar image for a region that includes a location of the media device, National Weather Service alerts or warnings for the region, live video feed of current conditions in the region, other weather data, or combinations thereof. The traffic information may include information related to road conditions, road closures, or both. The channel feeds may include content from a local news channel, a national news channel, or both.

The server may send the data stream to the media device via the terrestrial distribution system, at 306. The media device that receives the data stream may send output based on the data stream to one or more output devices coupled to the media device (e.g., a display device and sound system). The media device may insert into the output an indication that the satellite service is unavailable.

In response to a determination that the disruption ended, the server may end transmission of the data stream to the media device via the terrestrial distribution system, at 308. The server may determine that the disruption ended in response to receipt of a second message from the media device that indicates that the quality of content received by the media device via the satellite service is at or above a threshold quality. For example, referring to FIG. 1, the server 142 may determine that the disruption has ended in response to receipt of the second message 132. The second message may be received via the terrestrial distribution system, via the satellite distribution system, or both. The server may also determine that the disruption ended in response to an indication from the terrestrial distribution system that the data stream is not being received by the media device (e.g., the media device is not sending acknowledgment messages associated with reception of the data stream). The method 300 may then end, at 310.

Thus, the method of FIG. 3 enables the server of the satellite distribution system to generate a data stream from multiple content sources in response to receipt of the disruption message via the terrestrial distribution network from the media device. The server sends the data stream to the media device via the terrestrial distribution network. In response to receipt of a second message from the media device indicating that the media device is using the satellite service, the server stops transmission of the data stream to the media device. The data stream may be processed by the media device and may be sent to one or more output devices. The content of the output may inform one or more viewers that satellite service is disrupted and may provide the one or more viewers with emergency information and other information that may be informative to the one or more viewers.

FIG. 4 depicts a block diagram of a first embodiment of a display sent from a media device (e.g., the media device 104 of FIG. 1) to a display device 402 when satellite service to the media device is disrupted. The display device 402 of FIG. 4 may correspond to the display device 110 of FIG. 1. The display may include a satellite service indicator 404. The satellite service indicator 404 may inform a viewer of an availability (see FIG. 5) or an unavailability of a satellite service based on a quality of content received via the satellite service. The display may include current conditions 406. The current conditions 406 may present the time, date, current weather conditions, other information, or combinations thereof. The display may include a newsfeed 408 from a local news channel, a newsfeed from a national news channel 410, or both. The newsfeeds 408, 410 may correspond to channels available via the satellite service. A resolution associated with the newsfeeds 408, 410 may be low compared to a resolution of corresponding newsfeeds received via the satellite service. The low resolution may reduce bandwidth needed to send the newsfeeds 408, 410 to the media device. The display may include a weather radar image 412, weather alerts and/or warnings 414, road condition information 416, other windows, or combinations thereof. Such information may be obtained from internet-based sources, the National Weather Service, law enforcement departments, other sources, or combinations thereof. The display may also temporarily, or constantly, display a channel indicator 418 associated with the display.

Navigation and/or selection buttons of a remote control or other control device may be used to highlight and/or select particular information presented via the display device 402. Highlighted information may include or be associated with a visually distinct color or border (e.g., a blue border). Selecting the particular information may cause the border color associated with the particular information to change from a first color to a second color and may change a color of a border associated with previously selected information from the second color to a third color. Audio associated with the particular information that is selected may be output by the media device.

FIG. 5 depicts a block diagram of a second embodiment of a display sent from the media device to the display device 402 when the satellite service to the media device is available after the disruption. The media device may determine that the satellite service is available after the disruption based on a quality of content received via the satellite service satisfying a threshold quality for a particular period of time. When the satellite service becomes available after the disruption, the media device may change the satellite service indicator 404 to indicate that the satellite service is available. The media device may also send a change query 502 to the display. The change query 502 may prompt a viewer to indicate whether the viewer wishes to return to using the satellite service. To illustrate, in the example of FIG. 5, the change query 502 includes an accept option 504 and a deny option 506. The viewer may use the remote control or other control device to select one of the options 504, 506 and send corresponding data to the media device. In a first embodiment, when the media device does not receive data associated with a response to the change query 502 within a particular period of time (e.g., 30 seconds, 1 minute, 2 minutes, or some other time period), the media device may proceed as if the accept option 504 was received. In a second embodiment, when the media device does not receive data associated with a response to the change query 502 within the particular period of time, the media device may proceed as if the deny option 506 was received. When the media device receives data indicating selection of the accept option 504 or another acceptance event (e.g., activation of a channel up button, channel down button, entry of a particular channel number, etc. via the remote control), the media device may send a message to the satellite distribution system that causes the satellite distribution system to stop sending the media device a data stream that enables presentation of the information 404-418. The media device may determine a particular channel of content received via the satellite service to send to the display device 402 and send the particular content to the display device 402.

The particular channel may be determined based on the data indicating selection of the accept option or the equivalent. For example, if the data indicates selection of the accept option, the channel may correspond to a channel being viewed prior to the disruption. As another example, when the data indicates a selection of a particular channel via the remote control, the channel may be the particular channel.

When the media device receives data indicating selection of the deny option 506, the media device may continue displaying the information 404-418, may remove the change query 502, may add a change to satellite service button to the display, or combinations thereof. After passage of a particular amount of time, the media device may present the change query 502 again.

Various embodiments disclosed herein describe a satellite distribution system that sends information from multiple content sources to a media device via a terrestrial distribution system when satellite service to the media device via the satellite distribution system is disrupted. The ability to send the information to the media device may enable recipients of content based on the information to be aware of current conditions even though the satellite service is disrupted. The information may include alerts, warnings, and emergency information associated with one or more causes that resulted in disruption of the satellite service.

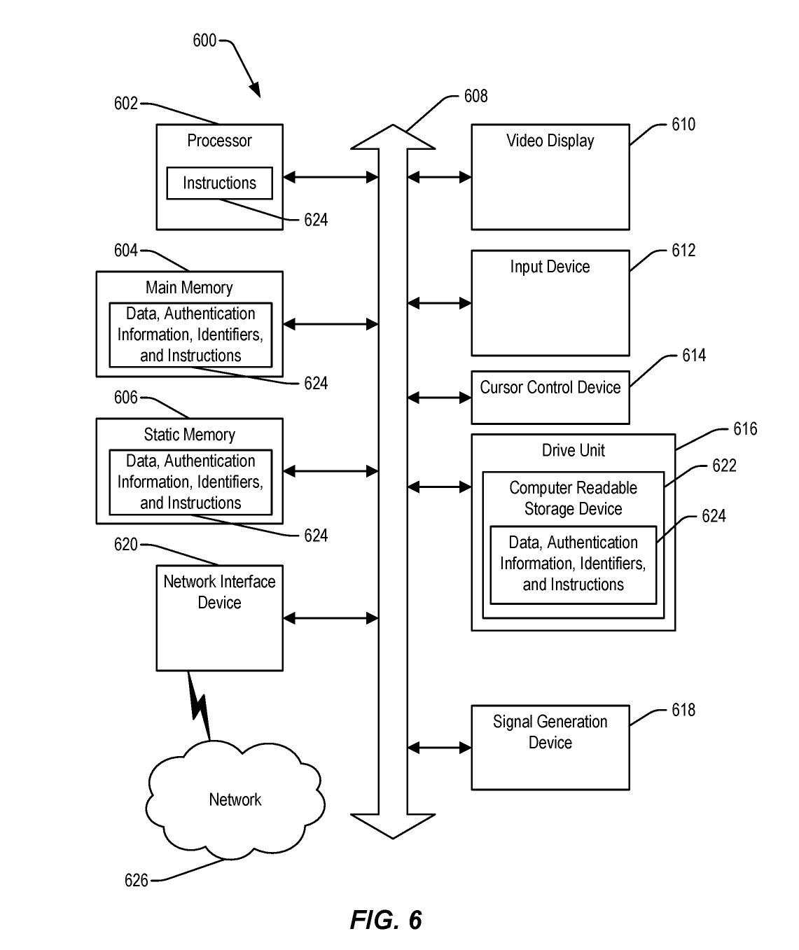

Referring to FIG. 6, an illustrative embodiment of a general computer system is shown and is designated 600. The computer system 600 includes a set of instructions (e.g., the instructions 624 in the memory 604) that can be executed to cause the computer system 600 to perform any one or more of the methods or computer based functions disclosed herein. The computer system 600 may operate as a standalone device or may be connected (e.g., using a network) to other computer systems or peripheral devices. For example, the computer system 600 may include or may be included within any one or more of the media device 104, the satellite distribution system 108, the display device 110, the terrestrial distribution system 112, the remote control 124, the satellite distribution equipment 134, the one or more satellites 136, the satellite receiver 138, the satellite uplink system 140, the terrestrial distribution equipment 148, the access point 152, or combinations thereof, described with reference to FIG. 1.

In a networked deployment, the computer system 600 may operate in the capacity of a server or as a client user computer in a server-client user network environment, or as a peer computer system in a peer-to-peer (or distributed) network environment. The computer system 600 may also be implemented as or incorporated into various devices, such as a server, a network device, a mobile device, a palmtop computer, a laptop computer, a desktop computer, a communications device, a wireless telephone, a personal computer (PC), a tablet PC, a personal digital assistant (PDA), a set-top box (STB) device, a media playback device, a customer premises equipment device, an endpoint device, a web appliance, or any other machine capable of executing a set of instructions (sequential or otherwise) that specify actions to be taken by that machine. In a particular embodiment, the computer system 600 may be implemented using electronic devices that provide video, audio, data communication, or combinations thereof. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602 (e.g., a central processing unit (CPU), a graphics processing unit (GPU), or both). Moreover, the computer system 600 may include a main memory 604 and a static memory 606, which can communicate with each other via a bus 608. As shown, the computer system 600 may further include a video display unit 610, such as a liquid crystal display (LCD), a light emitting diode (LED) display, a touch screen display, a flat panel display, a solid state display, or a lamp assembly of a projection system. Additionally, the computer system 600 may include an input device 612, such as a remote control device (e.g., a television remote or a set-top box remote), a keyboard, a joystick, another type of input device, or combinations thereof. In addition, the computer system 600 may include a cursor control device 614 (e.g., a mouse). In some embodiments, the input device 612 and the cursor control device 614 may be integrated into a single device, such as a capacitive touch screen input device. The computer system 600 may also include a drive unit 616, a signal generation device 618, such as a speaker or remote control, and a network interface device 620. Some computer systems 600 may not include an input device (e.g., a server may not include an input device).

In a particular embodiment, as depicted in FIG. 6, the drive unit 616 may include a computer-readable storage device 622 in which authentication information, identifiers, and one or more sets of instructions 624, e.g. software, can be embedded. The computer-readable storage device 622 may be random access memory (RAM), read-only memory (ROM), programmable read-only memory (PROM), erasable PROM (EPROM), electrically erasable PROM (EEPROM), one or more registers, solid-state memory, one or more hard disks, one or more removable disks, compact disc read-only memory (CD-ROM), other optical disk storage, magnetic disk storage, magnetic storage devices, or any other storage device usable to store program code in the form of instructions or data and that can be accessed by a computer and/or a processor. A computer-readable storage device is not a signal.

Further, the instructions 624 may embody one or more of the methods or logic as described herein. The instructions 624 may be executable by the processor 602 to perform one or more functions or methods described herein, such as the methods 200 and 300 described with reference to FIG. 2 and FIG. 3, respectively. In a particular embodiment, data (e.g., data corresponding to quality thresholds to determine whether received content satisfies a threshold quality), authentication information, identifiers, and instructions (e.g., instructions to determine the quality of content received via a satellite service, instructions to send a disruption message via a terrestrial distribution system when the quality does not satisfy the threshold quality, and instructions to output content of a data stream received via the terrestrial distribution system in response to the disruption message) 624 may reside completely, or at least partially, within the main memory 604, the static memory 606, and/or within the processor 602 during execution by the computer system 600. The main memory 604 and the processor 602 also may include a computer-readable storage device. The authentication information included in the authentication information, identifiers, and instructions 624 in the drive unit 616, the main memory 604, the static memory 606, the processor 602, or combinations thereof may be transmitted to another computer system to enable authentication of the computer system 600, and the identifiers may include a list of identifiers used to authenticate the other computer system, prior to sharing a resource with the other computer system.

In an alternative embodiment, dedicated hardware implementations, such as application specific integrated circuits, programmable logic arrays and other hardware devices, may be constructed to implement one or more of the methods described herein. Various embodiments may include a variety of electronic and computer systems. One or more embodiments described herein may implement functions using two or more specific interconnected hardware modules or devices with related control and data signals that can be communicated between and through the modules, or as portions of an application-specific integrated circuit (ASIC). Accordingly, the present system encompasses software, firmware, and hardware implementations.

In accordance with various embodiments of the present disclosure, the methods described herein may be implemented by software programs executable by a computer system, a processor, or a device, which may include forms of instructions embodied as a state machine implemented with logic components in an ASIC or a field programmable gate array (FPGA) device. Further, in an exemplary, non-limiting embodiment, implementations may include distributed processing, component/object distributed processing, and parallel processing. Alternatively, virtual computer system processing may be constructed to implement one or more of the methods or functionality described herein. It is further noted that a computing device, such as a processor, a controller, a state machine or other suitable device for executing instructions to perform operations may perform such operations directly or indirectly by way of one or more intermediate devices directed by the computing device.

The computer system 600 may communicate with one or more external systems via a network 626 and the network interface device 620. First data stored by the computer-readable storage device 622 may be sent to the one or more external systems via the network 626. Also, second data may be received by the computer system 600 via the network 626. The second data may be stored by the processor 602 at the computer-readable storage device. Additionally, while the computer-readable storage device 622 is shown to be a single device, the computer-readable storage device 622 may be a single device or may be multiple devices, such as a centralized or distributed database, and/or associated caches and servers that store one or more sets of instructions. The computer-readable storage device 622 is capable of storing a set of instructions for execution by the processor 602 to cause the computer system 600 to perform any one or more of the methods or operations disclosed herein.

In a particular non-limiting, exemplary embodiment, the computer-readable storage device 622 may include a solid-state memory such as embedded memory (or a memory card or other package that houses one or more non-volatile read-only memories). Further, the computer-readable storage device 622 may include a random access memory or other volatile re-writable memory. Additionally, the computer-readable storage device 622 may include a magneto-optical or optical device, such as a disk or tapes or other storage device. Accordingly, the disclosure is considered to include any one or more of a computer-readable storage device and other equivalents and successor devices, in which data or instructions may be stored.

Although the one or more components and functions may be described herein as being implemented with reference to particular standards or protocols, the disclosure is not limited to such standards and protocols. Such standards are from time-to-time superseded by faster or more efficient equivalents having essentially the same functions. Wireless standards for short-range communications and long-range communications can be used by the computer system 600 in selected embodiments.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Figures are also merely representational and may not be drawn to scale. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order unless expressly stated. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be implemented as multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, an application specific integrated circuit, and/or a programmable gate array (PGA) including a FPGA. In one or more embodiments, when a processor executes instructions to perform “operations”, this can include the processor performing the operations directly and/or facilitating, directing, or cooperating with another device or component to perform the operations.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
detecting, at a server of a satellite distribution system, a disruption in satellite service to a media device;
generating, at the server, a data stream from multiple content sources in response to the disruption; and
sending the data stream from the server to the media device via a terrestrial distribution system.

2. The method of claim 1, further comprising, in response to a determination that the disruption ended, ending transmission of the data stream to the media device via the terrestrial distribution system.

3. The method of claim 2, wherein the determination is based on receipt of a message from the media device, and wherein the message indicates reception by the media device of media content via the satellite service with a quality above a threshold quality for a period of time.

4. The method of claim 1, wherein the data stream includes video data, audio data, text data, or a combination thereof.

5. The method of claim 1, wherein the data stream includes weather information from a first content source of the multiple content sources, traffic information from a second content source of the multiple content sources, school closure information from a third content source of the multiple content sources, or combinations thereof.

6. The method of claim 1, wherein detecting the disruption includes receiving a disruption message from the media device via the terrestrial distribution system.

7. A system comprising:
a processor; and
a memory coupled to the processor, the memory storing instructions executable by the processor to perform operations including:
sending a disruption message to a network device of a satellite distribution system via a terrestrial distribution system in response to a determination that a quality of a content stream received via a satellite service from the satellite distribution system is below a threshold quality; and
receiving a data stream from the satellite distribution system via the terrestrial distribution system in response to the disruption message, wherein the satellite distribution system generates the data stream from multiple content sources in response to the disruption message.

8. The system of claim 7, further comprising a satellite interface to enable the processor to communicate with the satellite distribution system via the satellite service.

9. The system of claim 7, further comprising a network interface to enable the processor to communicate with the terrestrial distribution system.

10. The system of claim 7, wherein the operations further include providing particular content from the data stream to a display device.

11. The system of claim 10, wherein the particular content indicates that the satellite service is disrupted.

12. The system of claim 10, wherein the particular content includes weather information from a first content source of the multiple content sources, traffic information from a second content source of the multiple content sources, school closure information from a third content source of the multiple content sources, emergency information from a fourth content source of the multiple content sources, or combinations thereof.

13. The system of claim 10, wherein the operations further include, in response to a determination that the content stream received during reception of the data stream satisfies the threshold quality for a period of time, sending to the display device an indication of availability of the media content via the satellite communication and an option to change to content received via the satellite service, the content stream received via the satellite service and the data stream received via the terrestrial distribution system.

14. The system of claim 13, wherein the operations further include sending a second message to the satellite distribution system in response to acceptance of the option, wherein the satellite distribution system stops sending the data stream in response to the second message.

15. A computer-readable storage device storing instructions that, when executed by a processor, cause the processor to perform operations comprising:
sending a disruption message to a network device of a satellite distribution system via a terrestrial distribution system in response to a determination that a quality of media content received via a satellite service from the satellite distribution system is below a threshold quality; and
receiving a data stream from the satellite distribution system via the terrestrial distribution system in response to the disruption message, wherein the satellite distribution system generates the data stream from multiple content sources in response to the disruption message.

16. The computer-readable storage device of claim 15, wherein the operations further include sending particular content from the data stream to a display device.

17. The computer-readable storage device of claim 16, wherein the particular content indicates that the satellite communication is disrupted.

18. The computer-readable storage device of claim 16, wherein sending the particular content includes associating the particular content with a particular channel number.

19. The computer-readable storage device of claim 16, wherein the operations further include, in response to a determination that the content stream received during reception of the data stream satisfies the threshold quality for a period of time, sending to the display device an indication of availability of the media content via the satellite communication and an option to change to content received via the satellite service, the content stream received via the satellite service and the data stream received via the terrestrial distribution system.

20. The computer-readable storage device of claim 16, wherein the operations further include, in response to refusal of the option, sending the option to change to content received via the satellite service after passage of a first period of time.
